(19) United States
(12) Patent Application Publication
(10) Pub. No.: US 2016/0086502 A1
(43) Pub. Date: Mar. 24, 2016

(54) ONLINE LEARNING SYSTEM, SKILL EVALUATION METHOD THEREOF, AND STORAGE MEDIA STORING THE METHOD

(71) Applicant: INSTITUTE FOR INFORMATION INDUSTRY, Taipei (TW)

(72) Inventors: Chieh-Feng CHIANG, Taoyuan County (TW); Yong-Sing HUANG, Taichung City (TW); Yi CHIOU, Taipei City (TW)

(21) Appl. No.: 14/536,624

(22) Filed: Nov. 9, 2014

(30) Foreign Application Priority Data
Sep. 18, 2014 (TW) 103132290

(51) Int. Cl. G09B 7/00; G09B 5/02; G06Q 50/00; A63F 13/46; G06Q 50/20; G09B 5/06; A63F 13/67

(52) U.S. Cl. CPC G09B 7/00; G09B 5/06; G09B 5/02; A63F 13/67; A63F 13/46; G06Q 50/2057; G06Q 50/01

(57) ABSTRACT

An online learning system, a skill evaluation method thereof, and a storage media storing the method are provided in which the skill evaluation method thereof includes steps as follows. Providing at least one remote device to log in an online learning platform, quantifying a learning result of the online learning process executed by the remote device on the online learning platform to obtain a professional skill data, quantifying an online community interaction of the remote device on the online learning platform to obtain a soft skill data, and utilizing the professional skill data and the soft skill data.

### RELATED APPLICATIONS

This application claims priority to Taiwan Application Serial Number 103132290, filed Sep. 18, 2014, which is herein incorporated by reference.

### BACKGROUND

1. Field of Invention

The present invention relates to a skill evaluation method. More particularly, the present invention relates to a skill evaluation method of an online learning system.

2. Description of Related Art

With the development of network performance and website technology, the online learning course is a major trend in the field of education. The online learning course may be provided to learn and evaluate through a remote device and a network and without limited time.

For example, in Taiwan patent of publication No. 201027477, an online learning system is disclosed. The interactive online learning system may be provided to switch the remote online tutors arbitrarily according to user's learning result. It makes the learning system more flexible and optional. For instance, in Taiwan patent of publication No. 200847081, an online learning method is disclosed. During the learning course, the relative basic data and the statistic capacity and skill are provided to the remote device to assist learning. However, the information above may be not sufficient for the remote device to analyze user's skill thoroughly. The thorough performance of the remote device may not be reflected effectively, either. Accordingly, the issues may arise because of the inaccurate data.

For the forgoing reasons, there is a need for improving the defects and inconvenience of the technology above. Therefore, to solve the problems above is not only one important subject matter of development, but also an urgent need for the relative fields.

### SUMMARY

One aspect of this disclosure is providing a skill evaluation method of an online learning system to solve the defects and inconvenience of the prior art. The skill evaluation method of the online learning system may be implemented by a program and stored in a computer readable recording medium. Accordingly, after a computer accesses the computer readable recording medium above, the skill evaluation method of the online learning system may be executed. The skill evaluation method of the online learning system includes the steps as follows. Providing at least one remote device to log in an online learning platform; quantifying a learning result of the online learning process executed by the remote device on the online learning platform to obtain a professional skill data; quantifying an online community interaction of the remote device on the online learning platform to obtain a soft skill data; and utilizing the professional skill data and the soft skill data.

According to one or more embodiments of this disclosure, the step of quantifying the online community interaction of the remote device on the online learning platform to obtain the soft skill data further includes the following steps. When the remote device receives/transmits plural community interaction messages through the online learning platform, the messages are respectively quantified to first points, and the first points are calculated to be the first soft skill data of the remote device.

According to one or more embodiments of his disclosure, the skill evaluation method further includes the following steps. In the online learning process is executed by the remote device, the accomplishment of plural subsidiary subjects of at least one parent subject is quantified as a second soft skill data. Then, the second soft skill data is utilized.

According to one or more embodiments of this disclosure, the step of quantifying the accomplishment of plural subsidiary subjects of at least one parent subject further includes the following steps. A determination that whether at least one subsidiary subject is completed by the remote device is made. When the determination that the subsidiary subject being completed by the remote device is made, a second point is obtained by quantification according to a level of the subsidiary subject, and the second point is calculated to be a second soft skill data of the remote device.

According to one or more embodiments of this disclosure, the skill evaluation method further includes the following steps. The accomplishment efficiency executed by the remote device in the online learning process is quantified respectively to obtain a third soft skill data. Then, the third soft skill data is utilized.

According to one or more embodiments of this disclosure, the step of quantifying the accomplishment efficiency to obtain the third soft skill data further includes the following steps. A ratio of the actual spending time and the suggested accomplishment time of at least one subsidiary subject being accomplished by the remote device is calculated. The third point is obtained by quantification according to the ratio. The third point is then calculated to be the third soft skill data of the remote device.

According to one or more embodiments of this disclosure, the step of quantifying the accomplishment efficiency to obtain the third soft skill data further includes the following steps. A ratio of the actual spending time and the suggested accomplishment time of at least one parent subject being accomplished is calculated. The third point is obtained by quantification according to the ratio. The third point is calculated as the third soft skill data of the remote device.

According to one or more embodiments of this disclosure, the step of quantifying the learning result of the online learning process executed by the remote device on the online learning platform to obtain a professional skill data further includes the following steps. The remote device is provided to utilize at least one learning element of at least one of subsidiary subjects on the online learning platform. The learning result is quantified as a fourth point, and the fourth point is calculated to be the professional skill data of the remote device.

According to one or more embodiments of this disclosure, the step of quantifying the learning result as the fourth point further includes the following steps. When the online learning platform is utilized by the remote device, a reading time of the learning element is transformed into the fourth point when the online learning platform is utilized by the remote device, and the reading time of the learning element is proportional to the fourth point.

According to one or more embodiments of this disclosure, the step of quantifying the learning result as the fourth point further includes the following steps. A question correct rate of the learning element is transformed into the fourth point when the online learning platform is utilized by the remote device, and the question correct rate of the learning element is proportional to the fourth point.

According to one or more embodiments of this disclosure, the step of quantifying the learning result as the fourth point further includes the following steps. A game score of the learning element is transformed into the fourth point when the online learning platform is utilized by the remote device, and the game score is proportional to the fourth point.

According to one or more embodiments of this disclosure, the step of quantifying the learning result as the fourth point further includes the following step. The learning result is transformed into the fourth point according to a predetermined weight setting.

According to one or more embodiments of this disclosure, the step of utilizing the professional skill data and from the first to the third soft skill data further includes the following step. At least one of the professional skill data, and the first to the third soft skill data is graphed.

According to one or more embodiments of this disclosure, the step of utilizing the professional skill data and from the first to the third soft skill data further includes the following step. A percentile rank of the remote device with respect to other remote devices is provided in calculation according to at least one of the professional skill data and from the first to the third soft skill data for this remote device.

According to one or more embodiments of this disclosure, the step of utilizing the professional skill data and from the first to the third soft skill data further includes the following step. At least one of the professional skill data and from the first to the third soft skill data for this remote device is matched with a demand standard of at least one matching demand, and a matching result is generated.

Another aspect of this disclosure is providing an online learning system. The online learning system includes a server, and the server includes a network transmission device, a professional skill acquiring device, a soft skill acquiring device, a community interaction database, and a learner database. The network transmission device provides at least one remote device to log in the online learning system. The professional skill acquiring device quantifies the learning result of the online learning process executed by the remote device on the online learning platform to obtain a professional skill data. The soft skill acquiring device quantifies an online community interaction of the remote device on the online learning platform to obtain a first soft skill data. The learner database stores the professional skill data and the first soft skill data.

According to one or more embodiments of this disclosure, the soft skill acquiring device includes a community interaction database, a community interaction recording device, and a soft skill analyzing device. The community interaction recording device records the community interaction message which is transmitted/received from the online learning system by the remote device into the community interaction database. The community interaction messages are respectively quantified as first points. The soft skill analyzing device calculates the first points as the first soft skill data of the remote device.

According to one or more embodiments of this disclosure, the professional skill acquiring device includes a learning content database, a learning device and a professional skill analyzing device. The learning content database stores at least one parent subject having plural subsidiary subjects, and each of the subsidiary subjects includes at least one learning element. The learning device provides the remote device to use at least one learning element, records the learning result that the remote device using the learning element, and quantifies the learning result as a fourth point. The professional skill analyzing device calculates the forth point to be the professional skill data of the remote device.

According to one or more embodiments of this disclosure, the learning content database is provided with a checking table. The learning device refers to the checking table and quantifies the learning result as the fourth point according to the learning result.

According to one or more embodiments of this disclosure, the learning content database is provided with a weight setting table. The learning device refers to the weight setting table and quantifies the learning result as the fourth point according to the sort of one of the subsidiary subjects or the parent subject.

According to one or more embodiments of this disclosure, the professional skill acquiring device further quantifies the accomplishment of the subsidiary subjects of the parent subject executed by the remote device in the online learning process to obtain a second soft skill data.

According to one or more embodiments of this disclosure, the learning device further determines whether the remote device completes at least one of the subsidiary subjects, and quantifies to obtain a second point according to a level of the subsidiary subject when the remote device completing the subsidiary subject is determined, and also, the professional skill analyzing device calculates the second point as the second soft skill data of the remote device.

According to one or more embodiments of this disclosure, the learning device further determines whether the remote device completes all subsidiary subjects, and quantifies to obtain a second point according to the level of the parent subject when the remote device completing the subsidiary subject is determined, also, the professional skill analyzing device calculates the second point to be the second soft skill data of the remote device.

According to one or more embodiments of this disclosure, the professional skill acquiring device quantifies the accomplishment efficiency respectively of the online learning process executed by the remote device to obtain a third soft skill data.

According to one or more embodiments of this disclosure, the learning device calculates a ratio of the actual spending time and the suggested accomplishment time of each of the subsidiary subjects being accomplished by the remote device, and the learning device quantifies to obtain a third point respectively according to the ratio thereof, and the professional skill analyzing device calculates the third point to be the third soft skill data of the remote device.

According to one or more embodiments of this disclosure, the learning device further calculates the ratio of the actual spending time and the suggested accomplishment time for the parent subject being accomplished by the remote device. Then, the learning device quantifies to obtain the third point respectively according to the ratio, and the professional skill analyzing device calculates the third point to be the third soft skill data of the remote device.

According to one or more embodiments of this disclosure, the server further includes a graphing device. The graphing device graphs charts according to the professional skill data and from the first to the third soft skill data.

According to one or more embodiments of this disclosure, the server further includes a sorting device. The sorting device calculates the percentile rank of this remote device according to the professional skill data for this remote device and the other remote devices. The sorting device also calculates the percentile rank of this remote device according to one of the first to the third soft skill data for this remote device and for other remote devices.

According to one or more embodiments of this disclosure, the server further includes a matching device. The matching device matches at least one of the professional skill data and from the first to the third soft skill data for this remote device with a demand standard of at least one matching demand to generate a matching result.

To sum up, according to the skill evaluation method of this disclosure, not only the professional skill of a learner is analyzed during the online learning process, but also the soft skill of the learner is analyzed from his community interaction with others online. This method provides the learner with self-skill analysis and benefits his future application.

It is to be understood that both the foregoing general description and the following detailed description are by examples, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a flow chart of a skill evaluation method for an online learning system according to one embodiment of this invention;

FIG. 2 is a schematic drawing of an online learning system according to one embodiment of this invention;

FIG. 3 is a block diagram of a sever according to one embodiment of this invention;

FIG. 4 is a schematic drawing of a webpage for the online learning platform according to one embodiment of this invention;

FIG. 5 is a partial schematic drawing of a course plan for the online learning platform according to one embodiment of this invention;

FIG. 6 is a schematic drawing of a determining rule for the soft skill of the online learning platform according to one embodiment of this invention;

FIG. 7 is block diagram of a server according to another embodiment of this invention;

FIG. 8 is a percentile rank chart of the soft kill for all learners according to one embodiment of this invention; and

FIG. 9 is a schematic drawing of an online learning system according to one embodiment of this invention.

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts. According to the embodiments, it will be apparent to those skilled in the art that various modifications and variations can be made to the structure of the present invention without departing from the scope or spirit of the invention.

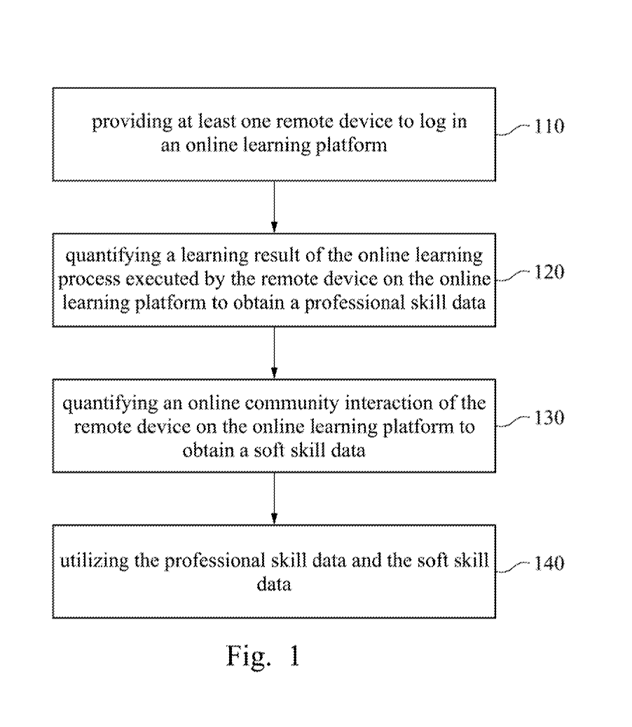

Referring to FIG. 1, FIG. 1 is a flow chart of a skill evaluation method for an online learning system according to one embodiment of this invention. According to the skill evaluation method of this disclosure, not only the professional skill of a learner is analyzed during the online learning process, but also the soft skill of the learner s analyzed from his community interaction with others online. It benefits learner's future application. The skill evaluation method of the online learning system may be implemented by a program and stored in a computer readable recording medium. Accordingly, after a computer accesses the computer readable recording medium above, the skill evaluation method of the online learning system may be executed. The computer readable recording medium may be a Read Only Memory (ROM), a Flash Memory, a soft disc, a Hard Disc, a Compact Disc, a magnetic tape, or a network database. It also may be any other computer readable recording medium with the same or equivalent function in this field.

The skill evaluation method includes the following steps. In Step 110, a remote device that is, a learner) is provided to log in an online learning platform. In Step 120, a learning result of the online learning process executed by the remote device on the online learning platform is quantified to obtain a professional skill data. In Step 130, an online community interaction of the remote device on the online learning platform is quantified to obtain a soft skill data. In Step 140, the professional skill data and the soft skill data are utilized.

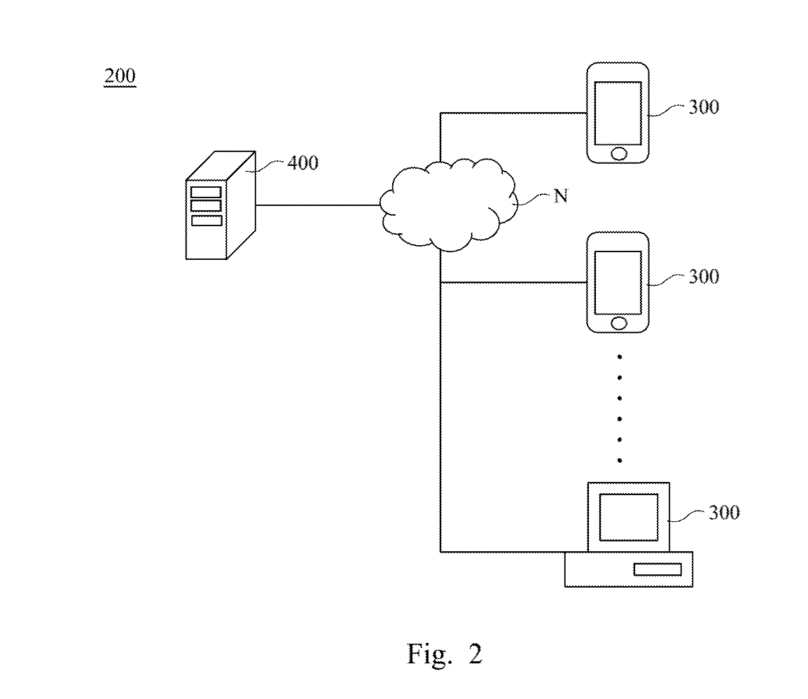

FIG. 2 is a schematic drawing of an online learning system 200 according to one embodiment of this invention. In the online learning system 200, not only the professional skill of a learner is obtained in the online learning process, but also the soft skill of the learner in community interactions with others online can be obtained as well for subsequent utilizations.

As shown in FIG. 2, the online learning system 200 includes one or more remote devices 300 and a server 400. The server 400 is connected to the remote devices 300 through the network N. As long as the remote device 300 is an internet-accessible device, the remote devices 300 can be, but not limit to, a mobile phone, a laptop computer, a tablet computer, or a desktop computer. The server 400 includes an online learning platform. By the way of a platform entrance of the online learning platform, one of the remote devices 300 may enter the online learning platform of the server 400 through the network N. Thus, any of the remote devices 300 may connect the server 400 through the network N for logging in the online learning platform of the server 400.

For example, the platform entrance may be a homepage of the learning website, or a learning-used application for smart phones in the remote device. However, the platform entrance of this invention is not limited to those above, it also may be a USB device connected to the remote device 300 directly.

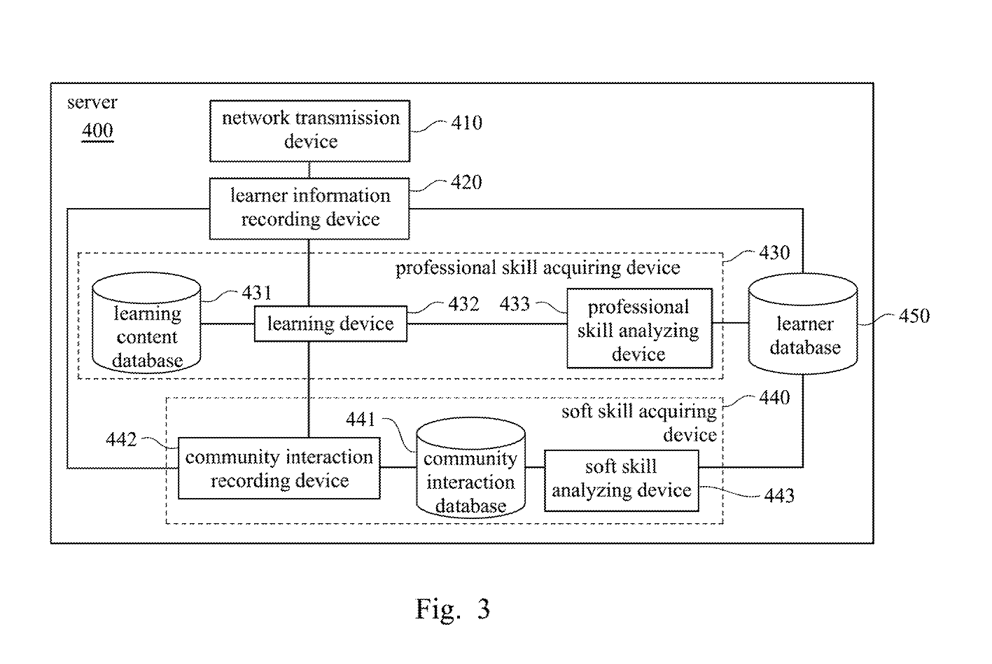

FIG. 3 is a block diagram of the sever 400 according to one embodiment of this invention. In this embodiment, the server 400 includes a network transmission device 410 (e.g., a network card), a learner information recording device 420, an professional skill acquiring device 430, a soft skill acquiring device 440, and a learner database 450.

The network transmission device 410 provides the aforementioned remote devices 300 (i.e., learners) for logging in the online learning platform through networks. The learner information recording device 420 is connected to the network transmission device 410, the soft skill acquiring device 440, the learner database 450 and the professional skill acquiring device 430. The learner information recording device 420 provides the remote devices (i.e., learners) with recording or registering learner information. The learner information can be basic information, professional certification license information and/or result work(s), however, the disclosure is not limited thereto.

The learner database 450 is connected to the professional skill acquiring device 430, the soft skill acquiring device 440, and the learner information recording device 420. The professional skill acquiring device 430 is connected to the soft skill acquiring device 440, and quantifies a learning result of the online learning process executed by one of the remote devices 300 (i.e., a learner) on the online learning platform to obtain a professional skill data. The professional skill data is stored in the learner database for sequent utilizations. The soft skill acquiring device 440 quantifies an online community interaction of the remote device 300 (i.e. the learner) on the online learning platform to obtain a first soft skill data. The first soft skill data is stored in the learner database 450 for sequent utilizations.

The soft skill acquiring device 440 includes a community interaction database 441, a community interaction recording device 442, and a soft skill analyzing device 443. The community interaction database 441 is connected to the community interaction recording device 442 and the soft skill analyzing device 443. When the remote device 300 receives and/or transmits plural community interaction messages through the online learning platform, the community interaction recording device 442 records the community interaction messages into the community interaction database 441 and quantifies the community interaction messages as one first point, respectively. In practice, one way to quantify one of the message as the first point is to use a checking table for recognizing the kinds of the message and the corresponding first point thereof. However, this invention is not limited to the usage of the checking table, for example, it may be accomplished only by calculating. The soft skill analyzing device 443 is connected to the learner database 450, and calculates (e.g., sum up or average) the first points to be the first soft skill data of the remote device 300 (i.e., the learner). Then, the first soft skill data is stored into the learner database 450.

The professional skill acquiring device 430 includes a learning content database 431, a learning device 432 and a professional skill analyzing device 433. The learning content database 431 stores at least one parent subject (i.e., program, course or subsidiary course). The parent subject includes plural subsidiary subjects (i.e., hurdles) and each of the subsidiary subjects includes at least one learning element. For example, each program includes plural courses or subsidiary courses, and each of the courses or subsidiary courses includes plural hurdles. Therefore, when the hurdles are defined as the subsidiary subject, the program, course or subsidiary course is defined as the parent subject of the hurdles.

The learning device 432 is connected to the professional skill analyzing device 433, learning content database 431, the community interaction recording device 442 and learner information recording device 420. The learning device 432 provides the remote device 300 with at least one learning element for using, records the learning results of the remote device 300 (i.e., the learner), and respectively quantifies the learning results as fourth points. The professional skill analyzing device 433 is connected to the learner database 450, and calculates (e.g., sum up or average) the forth points to be the professional skill data of the remote device 300 (i.e., the learner).

Specifically, a checking table is provided and stored in the learning content database 431. The checking table records the relationship between the levels of the learning results and the fourth points corresponding to the levels of the learning results. Therefore, when the learning device 432 refers to the checking table, the learning result may be quantified as the forth point according to the level of the learning result. However, this invention is not limited to the usage of the checking table, for example, it may be accomplished only by calculating. For instance, in other embodiment, a weight setting table is provided and stored in the learning content database 431. The weight setting table records the relationship between the levels of the learning results and the corresponding setting weights. The learning device 432 refers to the weight setting table and quantifies the learning results as the fourth points according to the sorts of the subsidiary subjects or the parent subject. However, this invention is not limited to the usage of the weight setting table, for example, it may be accomplished only by calculating.

The professional skill acquiring device 430 respectively quantifies the accomplishments of the subsidiary subjects of at least one parent subject being executed by the remote device in the online learning process so as to obtain a second soft skill data. Then, the second soft skill data is stored in the learner database 450 for sequent utilizations. In practice, for this embodiment, the learning device 432 is utilized to determine whether the remote device 300 completes to utilize one of the subsidiary subjects. When the remote device 300 completing to utilize the subsidiary subject is determined by the learning device 432, the learning device 432 quantifies to obtain a second point according to the level of the subsidiary subject. Besides, the learning device 432 is further utilized to determine whether the remote device 300 completes to utilize all subsidiary subjects. When the remote device 300 completing to utilize all subsidiary subjects is determined by the learning device 432, the learning device 432 of the professional skill acquiring device 430 quantifies a second point according to the level of the parent subject. In practice, one way to quantify for the second point is to use a checking table in which the second point is checked out in accordance with the level of the subsidiary subject being filled in the checking table. However, this invention is not limited to the usage of the checking table, for example, it may be accomplished only by calculating. The professional skill analyzing device 433 of the professional skill acquiring device 430 is utilized to calculate (e.g., sum up or average) the second point as the second soft skill data of the remote device 300.

Besides, the professional skill acquiring device 430 is further utilized to quantify the accomplishment efficiency respectively in the online learning process being executed by the remote device 300, so as to obtain a third soft skill data. Then, the third soft skill data is stored in the learner database 450 for sequent utilizations. In practice, the learning device 432 of the professional skill acquiring device 430 is further utilized to calculate the ratio of the actual spending time and the suggested accomplishment time for the accomplished subsidiary subject or the accomplished parent subject. Then, the learning device 432 respectively quantifies to obtain the third point according to the ratio. In practice, one way to quantify for the third point is to use a checking table in which the third point is checked out in accordance with the ratio filled in the checking table. However, this invention is not limited to the usage of the checking table, for example, it may be accomplished only by calculating. The professional skill analyzing device 433 of the professional skill acquiring device 430 is utilized to calculate (e.g., sum up or average) the third point to be the third soft skill data of the remote device 300.

Accordingly, as shown in FIG. 3, when the remote device (i.e., the learner) logs in the homepage of the online learning platform through the network transmission device 410 (or platform entrance), the remote device (i.e., the learner) needs to register the learner information through the learner information recording device 420 (includes but not limits to account and password). Later, according to the private account and password, the remote device (i.e., the learner) may access the content of the online learning platform through the learning device 432. For example, the learning device 432 provides the remote device (i.e., the learner) with the learning element (includes courses, films, articles etc.) stored in the learning content database 431 for using.

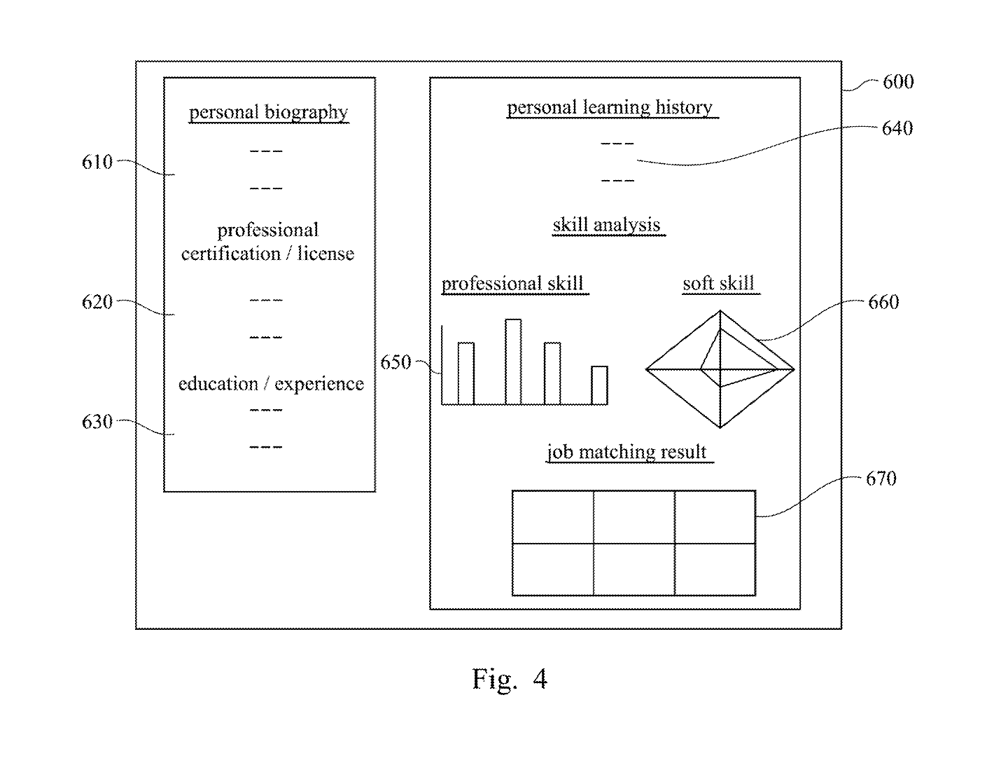

FIG. 4 is a schematic drawing of a webpage 600 for the online learning platform according to one embodiment of this invention. As shown in FIG. 3 and FIG. 4, in this embodiment, when the remote device (Le the learner) enters the webpage 600 for the private account, the webpage 600 displays a “personal biography” field 610, a “professional certification/license” field 620 and an “education/experience” field 630. Accordingly, the information stored in the learner database 450 may be displayed on the aforementioned fields 610-630 respectively. Besides, the webpage 600 further displays a “personal learning history” field 640, a “professional skill” field 650 and a “soft skill” field 660. Therefore, the previous learning history for the learner may be obtained by accessing the learner database 450 and be displayed in the “personal learning history” field 640.

The professional skill and the soft skill for the learner analyzed previously may be displayed in the “professional skill” field 650 and the “soft skill” field 660 in a chart form. However, in other embodiments, the professional skill and the soft skill for the learner analyzed previously may be shown in the “professional skill” field 650 and the “soft skill” field 660 in other way (e.g., digitalization).

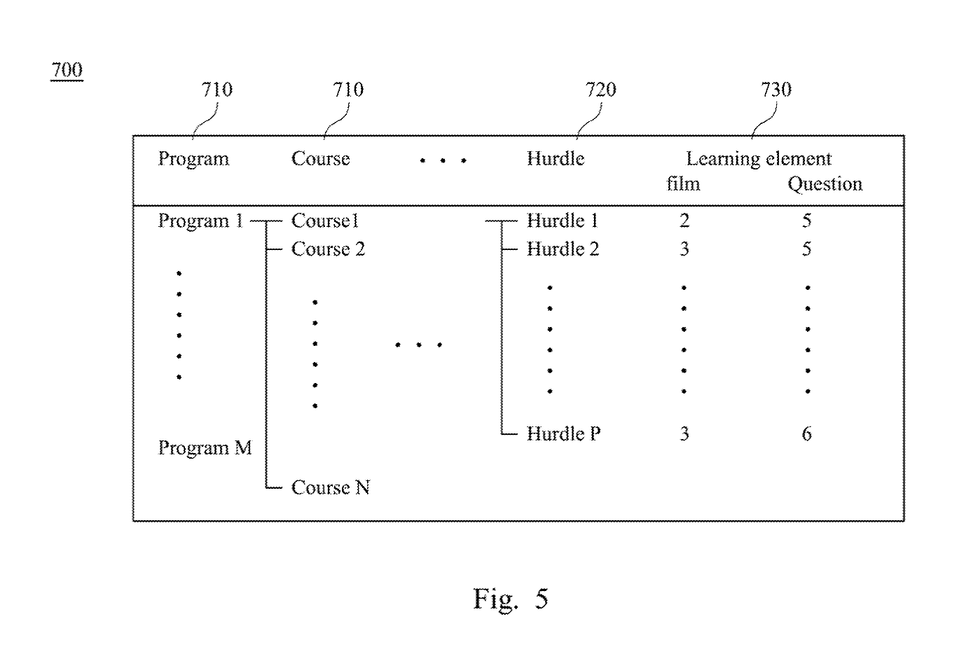

FIG. 5 is a partial schematic drawing of a course plan 700 for the online learning platform according to one embodiment of this invention. As shown in FIG. 5, because the course plan 700 is in the multi-stage structure, from high to low, the stages are, for example, programs, courses, and hurdles in sequence. Thus, programs and courses are defined as parent subjects 710, while hurdles are defined as subsidiary subjects 720. Accordingly, the remote device (i.e., the learner) may use the content of the online learning platform in sequence as required. However, the quantity of the stages is not limited. For example, in other embodiment, the stages above may be replaced by the stages of programs, courses, subsidiary courses and hurdles.

Further, in order to realize the learning performance of the remote device (i.e., the learner), each of the subsidiary subjects 720 (e.g., hurdles) has learning elements 730. The learning elements are, but not limited to, films, articles, questions and or games. For instance, in the course plan 700 in FIG. 5, the learning elements 730 of the subsidiary subjects 720 (e.g., hurdles) are films and questions.

As shown in FIG. 3 and FIG. 5, after the remote device (i.e., the learner) studies the content of the subsidiary subject 720 (e.g., hurdles), it may utilize the learning element 730 to realize the learning result optionally. The ranking of the learning element 730 helps to determine whether the subsidiary subject 720 (e.g., hurdles) is completed (i.e., passed). The learning device 432 may record every learning result for the learning element 730 generated by the remote device (i.e., the learner), and quantify these learning results as the fourth points. Finally, the professional skill analyzing device 433 may calculate (e.g., sum up or average) the fourth points for every quantified learning result to be the professional skill data. The professional skill data then is stored at the corresponding address for the remote device the learner) in the learner database 450.

For example, when the learning element 730 is a film, the learning device 432 may calculate the fourth point according to the watching time for the remote device (i.e., the learner). Accordingly, the professional skill analyzing device 433 may calculate the professional skill data for the remote device (i.e., the learner). The professional skill data is stored at the corresponding address for the remote device (i.e., the learner) in the learner database 450. The length of watching time for the film is proportional to the fourth point. Besides, when the learning device 432 detects that the time length that the film being watched is longer than a predetermined ratio of the full length of the film, the learning device 432 determines that the remote device (i.e., the learner) has completed this subsidiary subject 720 (i.e., hurdle) and vice versa.

For another example, when the learning elements 730 are questions, the learning device may transform question correct rate of the remote device e., the learner) to the fourth point. Accordingly, the professional skill analyzing device 433 may calculate the professional skill data of the remote device (i.e., the learner). The professional skill data is stored at the corresponding address for the remote device (i.e.; the learner) in the learner database 450. The question correct rate for the questions is proportional to the fourth point. practice, if the remote device (i.e., the learner) correctly answers the question till the second time, the learning device 432 may discount the fourth point.

For another example, when the learning element 730 is an interaction game, the learning device 432 may calculate to get the fourth point according to the game score granted by the remote device (i.e., the learner). Accordingly, the professional skill analyzing device 433 may calculate the professional skill data of the remote device (i e., the learner). The professional skill data is stored at the corresponding address for the remote device (i.e., the learner) in the learner database 450. The game score is proportional to the fourth point.

However, it should be understood that the quantifications of the learning result above are merely examples and those should not limit this invention. The person with ordinary knowledge in the art may select other implementing method as required.

It should be understood that under the same or different parent subjects (e.g., courses), the difficulties of the learning elements for all subsidiary subjects (e.g., hurdles) are various. Therefore, it may set different weights corresponding to the different learning elements to generate respective fourth points as required.

In addition to utilizing the content of the online learning platform, the remote device (i.e., the learner) may execute community interactions with other remote devices (i.e., other learners) on the online learning platform. The interactions may be, for example, question & answer, discussion, sharing and replying the learning elements above (including courses, films, articles and so on), and recommending or encouraging other learners. However, this invention is not limited to those above, the remote device (i.e., the learner) may execute course learning and community interaction independently.

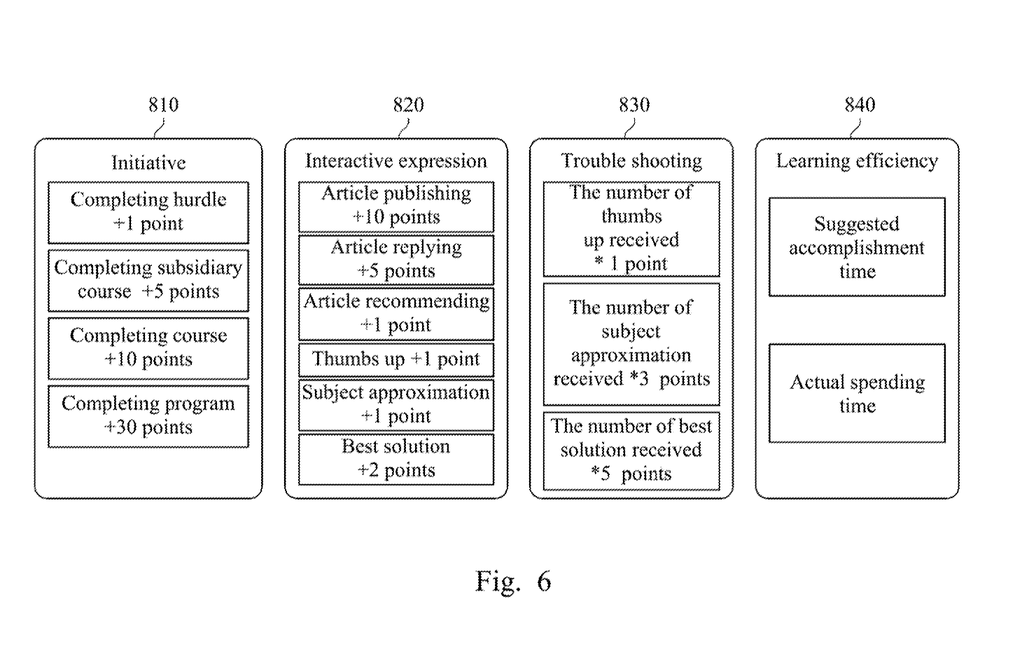

FIG. 6 is a schematic drawing of a determining rule for the soft skill of the online learning platform according to one embodiment of this invention. As shown in FIG. 6, according to the community interactions between the remote device (i.e., the learner) and others on the online learning platform, the soft skill for this learner may be analyzed. In this embodiment, the soft skills, that is, non-technical skills are classified into four categories: Initiative 810, Interactive expression 820, Trouble shooting 830 and Learning efficiency 840. Interactive expression 820 and Trouble shooting 830 correspond to the first soft skill data. Initiative 810 corresponds to the second soft skill data. Learning efficiency 840 corresponds to the third soft skill. However, this invention is not limited to those above.

As shown in FIG. 3 and FIG. 6, in Initiative 810 category, when the learning device 432 determines that the remote device (i.e., the learner) completes a subsidiary subject, the learning device 432 quantifies the second point according to the level of the subsidiary subject respectively. For example, whenever one hurdle is completed, the learning device records that the remote device (i.e., the learner) grants one point for the second point. When the learning device 432 determines that the remote device (i.e., the learner) completes to utilize all subsidiary subjects, the learning device quantifies to obtain the second point according to the level of the parent subject respectively. For example, whenever all hurdles of a subsidiary course are completed to utilize, the learning device records that the remote device (i.e., the learner) grants another five points for the second point.

Finally, the professional skill analyzing device 433 may calculate (e.g., sum up or average) all the second points granted by the remote device (i.e., the learner) as the second soft skill data for Initiative 810 category. The second soft skill data is stored at the corresponding address for the remote device (i.e., the learner) in the learner database 450.

In Interactive expression 820 and Trouble shooting 830 categories, when the remote device (i.e., the learner) releases a community interaction message to other remote devices (specific learners or nonspecific learners) or receives a community interaction message from other remote devices (specific learners or nonspecific learners), the community interaction recording device 442 quantities the community interaction message as the first point according to the kind of the community interaction record. The first point is stored in the community interaction database 441 and is accumulated into the first soft skill data of the remote device (i.e., the learner). For example, the community interaction message may be an article publishing message, an article replying message, an article recommending message, a thumbs up message, a subject approximation message, a best solution message or/and a virtual gift giving message. However, this invention is not limited to those above. For example, whenever an article is published by the learner, the community interaction recording device 422 records that the remote device (i.e., the learner) grants ten points for the first point. For another example, whenever an article is replied by the learner, the community interaction recording device 422 records that the remote device (i.e., the learner) grants five points for the first point. For yet another example, the community interaction recording device 422 counts the number of thumbs up message received from other remote devices (specific learners or nonspecific learners) as the first point granted. Because the online learning platform 500 has a clear operation interface, the community interaction recording device 422 may obtain the article publishing message, the article replying message, the article recommending message, the thumbs up message, the subject approximation message, the best solution message and the virtual gift giving message clearly. Finally, the soft skill analyzing device 443 may calculate (e.g. sum up or average) the first point in the community interaction database 441 as the second soft skill data for Interactive expression 820 and Trouble shooting 830 categories. The first soft skill data is stored at the corresponding address for the remote device (i.e., the learner) in the learner database 450.

It should be understood that the Interactive expression 820 category is related to that the remote device (i.e., the learner) releases the community interaction message to other remote devices (specific learners or nonspecific learners), and the Trouble shooting 830 category is related to that the remote device (i.e., the learner) receives the community interaction message from other remote devices (specific learners or nonspecific learners). Therefore, the person with ordinary knowledge in this art may easily distinguish or combine Interactive expression 820 and Trouble shooting 830 categories in the first soft skill data.

In learning efficiency 840 category, when the learning device 432 calculates the ratio of the actual spending time and the suggested accomplishment time for the accomplished subsidiary subject respectively. Then, the learning device 432 quantifies the third point respectively according to the ratio. Finally, the professional skill analyzing device 433 may calculate (e.g., sum up or average) the third point granted by the remote device (i.e.; the learner) as the third soft skill data for learning efficiency 840 category. The third soft skill data is stored at the corresponding address for the remote device (i.e., the learner) in the learner database 450.

It should be understood that the features of the soft skill categories are not invariant, those may be amended by verification to satisfy the requirement. For example, first, the platform is configured to acquire and analyze the skill according to the function definition and the market demand. Then, said community interaction is recorded and analyzed to obtain the skill data. Finally, the analysis result of the platform is verified by questionnaire and evaluation.

In practice, for the skill evaluation method of this invention, the professional skill and the soft skill may be charted, especially for the professional skill data, and from the first to the third soft skill data. However, this invention is not limited to those above.

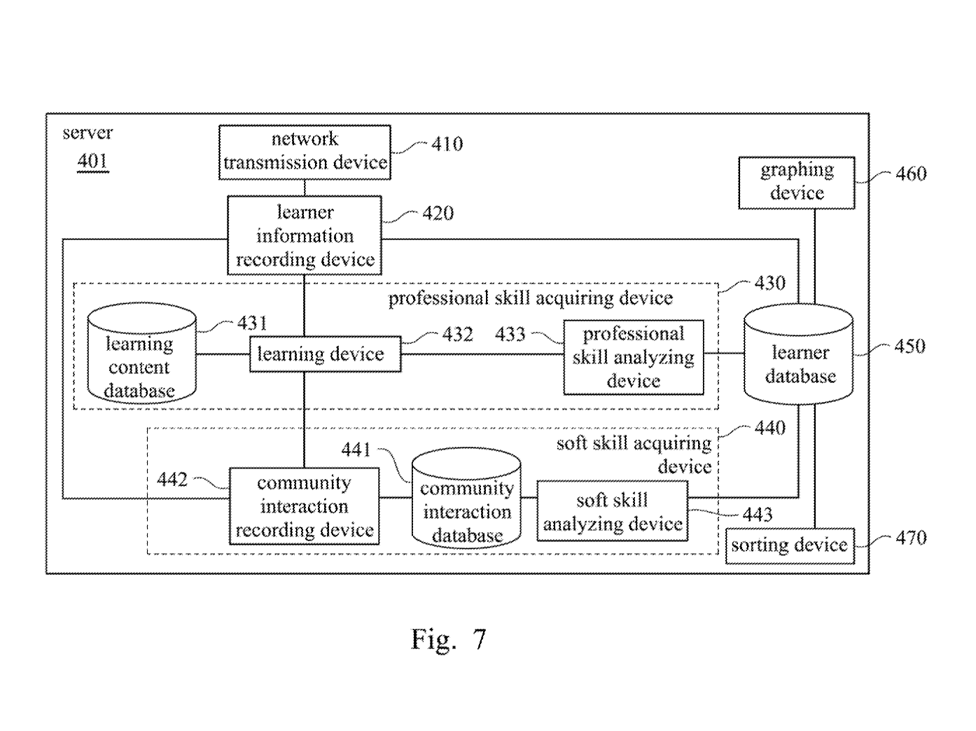

FIG. 7 is block diagram of a server 401 according to another embodiment of this invention. As shown in FIG. 7, the server 401 further includes a graphing device 460. The graphing device 460 is connected to the learner database 450, and is utilized to draw charts according to at least one of the professional skill data and from the first to the third soft skill data. For example, as shown in FIG. 4 and FIG. 7, the graphing device 460 draws charts and displays them in the “professional skill” field 650 and the “soft skill” field 660 according to the professional skill data and from the first to the third soft skill data in the learner database.

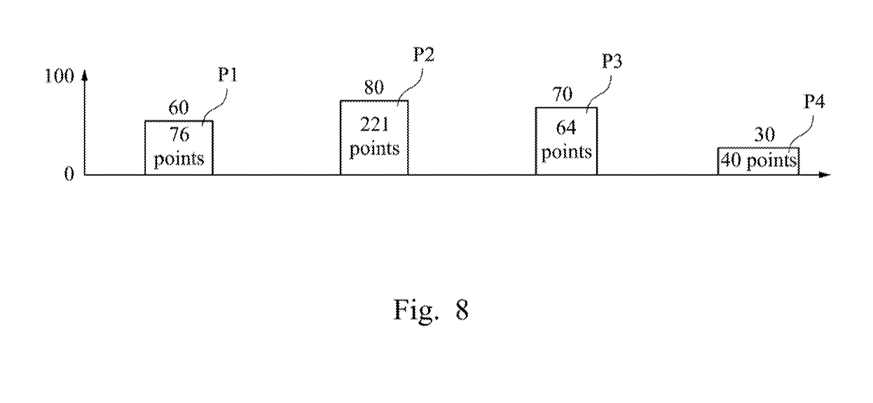

In practice, for the skill evaluation method of this invention, the professional skill and the soft skill may be sorted in percentile ranking. However, this invention is not limited to those above. FIG. 8 is a percentile rank chart of the soft skill for all learners according to one embodiment of this invention. As shown in FIG. 7 and FIG. 8, the server further includes a sorting device 470. The sorting device 470 is connected to the learner database 450, and is utilized to sort the percentile rank of the remote devices according to the third soft skill data for this remote device and for other remote devices. The graphing device 460 draws four charts P1˜P4 for Initiative 810, Interactive expression 820, Trouble shooting 830 and Learning efficiency 840 categories according to the percentile rank of the remote device respectively.

However, this invention is not limited to those above. The sorting device 470 may sort the percentile rank of the remote device according to the professional′ skill data for this remote device and for other remote devices.

In practice, for the skill evaluation method of this invention, the professional′ skill and the soft skill may be matched with job vacancy. However, this invention is not limited to those above.

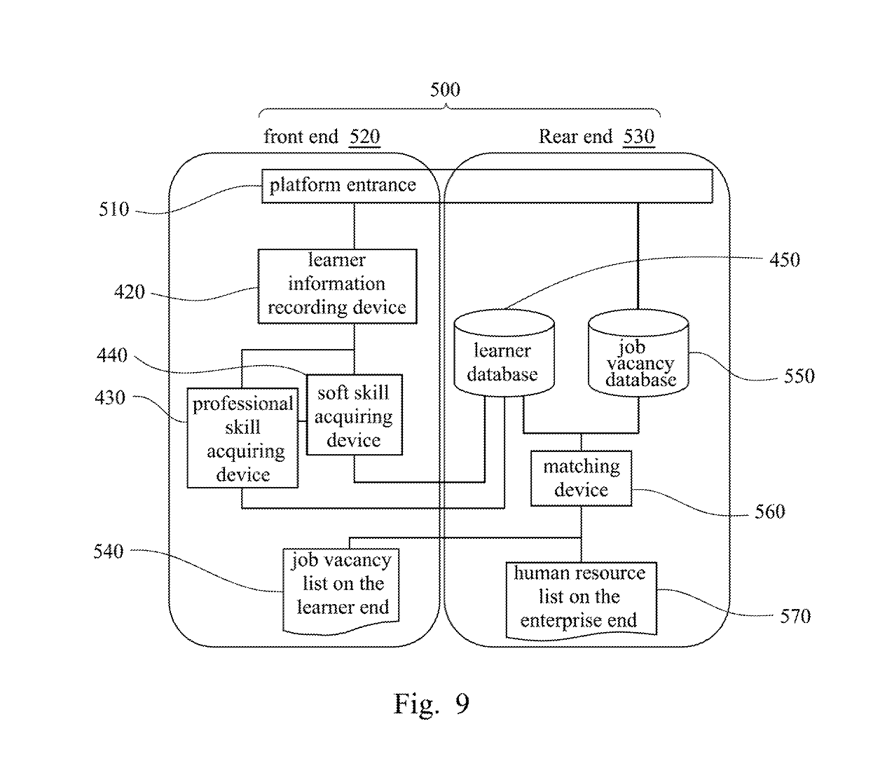

FIG. 9 is a schematic drawing of an online learning system 200 according to one embodiment of this invention. As shown in FIG. 9, according to the concept of the online learning platform 500, the online learning platform 500 is divided into the front end 520 of the platform, the rear end 530 of the platform, the platform entrance 510, the recording device 420 for learner information, the acquiring device 430 for professional skill and the acquiring device 440 for soft skill in the front end 520, and the list of job vacancy for the learner end. The details are not described repeatedly herein. The rear end 530 has the learner database 450, job vacancy database 550 and the matching device 560. The matching device 560 is connected to the learner database 450 and the job vacancy database 550. The job vacancy database 550 collects plural job vacancies from the enterprise end wherein each of the job vacancies has a position standard and a demand standard.

The matching device 560 matches at least one of the professional skill data and from the first to the third soft skill data for this remote device with a demand standard of at least one matching demand (e.g., job vacancy, school integration). In this embodiment, the matching device 560 matches at least one of the professional skill data and from the first to the third soft skill data for this remote device (i.e., the learner) with a demand standard of at least one job vacancy in the job vacancy database, and to generate a matching result., and to generate a matching result. The matching result is displayed in a human resource list 570 on the enterprise end, and in a job vacancy list 540 on the learner end partially or thoroughly. The job vacancy list 540 on the learner end may be responded in field 670 for “matching result for job vacancy” at the lower part of the webpage 600 in FIG. 4.

It should be understood that the learner information recording device, the professional skill acquiring device, the soft skill acquiring device, the graphing device and the sorting device may be a software/a firmware, or an integration of a processor (e.g., CPU, CPU or single chip) and a software/a firmware executed thereby. The database mentioned above may be a storage device or a portion storing space in a storage device.

To sum up, according to the skill evaluation method of this disclosure, not only the professional skill of a learner is analyzed during the online learning process, but also the soft skill of the learner is analyzed from his community interaction with others online. This method provides the learner with self-skill analysis and benefits his future application.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A skill evaluation method of the online learning system comprising:
providing at least one remote device to log in an online learning platform;
quantifying a learning result of an online learning process executed by the remote device on the online learning platform to obtain a professional skill data;
quantifying an online community interaction of the remote device on the online learning platform to obtain a first soft skill data; and
utilizing the professional skill data and the first soft skill data.

2. The skill evaluation method of claim 1, wherein the step of quantifying the online community interaction of the remote device on the online learning platform to obtain the first soft skill data further comprises:
when the remote device receives or transmits a plurality of community interaction messages through the online learning platform, respectively quantifying the community interaction messages as first points, and calculating the first point to be the first soft skill data of the remote device.

3. The skill evaluation method of claim 2, wherein the community interaction messages are selected from a group consisting of an article publishing message, an article replying message, an article recommending message, a thumbs up message, a subject approximation message, a best solution message and a virtual gift giving message.

4. The skill evaluation method of claim 1, wherein the step of utilizing the professional skill data and the first soft skill data further comprises:
graphing charts according to the first soft skill data.

5. The skill evaluation method of claim 1, wherein the step of utilizing the professional skill data and the first soft skill data further comprises:
calculating to provide a percentile rank of the remote device with respect to other remote devices according to the first soft skill data of the remote device and other soft skill data of the other remote devices.

6. The skill evaluation method of claim 1, wherein the step of utilizing the professional skill data and the first soft skill data further comprises:
matching at least one of the professional skill data and the first soft skill data of the remote device with a demand standard of at least one matching demand to generate a matching result.

7. The skill evaluation method of claim 1, further comprising:
quantifying accomplishments of a plurality of subsidiary subjects of at least one parent subject executed by the remote device in the online learning process to obtain a second soft skill data; and
utilizing the second soft skill data.

8. The skill evaluation method of claim 7, wherein the step of quantifying the accomplishments of the subsidiary subjects of the parent subject executed by the remote device in the online learning process to obtain the second soft skill data, further comprises:
determining whether at least one of the subsidiary subjects executed by the remote device is completed;
quantifying to obtain a second point respectively according to a level of the subsidiary subject when the subsidiary subject executed by the remote device which is completed is determined; and
calculating the second point to be the second soft skill data of the remote device.

9. The skill evaluation method of claim 7, wherein the step of quantifying the accomplishment of the subsidiary subjects of the parent subject executed by the remote device in the online learning process to obtain the second soft skill data, further comprises:
determining whether all of the subsidiary subjects of the parent subject executed by the remote device are completed;
quantifying to obtain a second point according to a level of the parent subject when all of the subsidiary subjects of the parent subject executed by the remote device which are completed is determined; and
calculating the second point to be a second soft skill data of the remote device.

10. The skill evaluation method of claim 7, wherein the step of utilizing the second soft skill data further comprises:
graphing charts according to the second soft skill data.

11. The skill evaluation method of claim 7, wherein the step of utilizing the second soft skill data further comprises:
calculating to provide a percentile rank of the remote device with respect to other remote devices according to the second soft skill data of the remote device and other soft skill data of other remote devices.

12. The skill evaluation method of claim 7, wherein the step of utilizing the second soft skill data further comprises:
matching at least one of the professional skill data, the first soft skill data and the second soft skill data of the remote device with a demand standard of at least one matching demand to generate a matching result.

13. The skill evaluation method of claim 1, further comprising:
quantifying accomplishment efficiency respectively by the remote device in the online learning process to obtain a third soft skill data; and
utilizing the third soft skill data.

14. The skill evaluation method of claim 13, wherein the step of quantifying the accomplishment efficiency respectively by the remote device in the online learning process to obtain the third soft skill data, further comprises:
calculating a ratio of actual spending time and suggested accomplishment time of at least one subsidiary subject being accomplished by the remote device, respectively;
quantifying to obtain a third point according to the ratio thereof respectively; and
calculating the third point to be the third soft skill data of the remote device.

15. The skill evaluation method of claim 13, wherein the step of quantifying the accomplishment efficiency respectively by the remote device in the online learning process to obtain the third soft skill data, further comprises:
calculating a ratio of actual spending time and suggested accomplishment time of at least one parent subject being accomplished by the remote device, respectively;
quantifying to obtain a third point according to the ratio respectively; and
calculating the third point to be the third soft skill data of the remote device.

16. The skill evaluation method of claim 13, wherein the step of utilizing the third soft skill data further comprises:
graphing charts according to the third soft skill data.

17. The skill evaluation method of claim 16, wherein the step of utilizing the third soft skill data further comprises:
calculating to provide a percentile rank of the remote device with respect to other remote devices according to the third soft skill data for the remote device and other soft skill data of the other remote devices.

18. The skill evaluation method of claim 16, wherein the step of utilizing the third soft skill data further comprises:
matching at least one of the professional skill data, the first soft skill data and the third soft skill data for the remote device with a demand standard of at least one matching demand to generate a matching result.

19. The skill evaluation method of claim 1, wherein the step of quantifying the learning result of the online learning process executed by the remote device on the online learning platform to obtain the professional skill data further comprises:
providing the remote device to utilize at least one learning element of at least one of subsidiary subjects on the online learning platform;
recording the learning result of the learning element utilized by the mote device on the online learning platform; and
quantifying the learning result as a fourth point, and calculating the fourth point to be the professional skill data of the remote device.

20. The skill evaluation method of claim 19, wherein the learning element is selected from a group consisting of a film, an article, a question and a game.

21. The skill evaluation method of claim 19, wherein the step of quantifying the learning result as the fourth point, further comprises:
transforming a reading time of the learning element into the fourth point when the online learning platform is utilized by the remote device, wherein the reading time of the learning element is proportional to the fourth point.

22. The skill evaluation method of claim 19, wherein the step of quantifying the learning result as the fourth point, further comprises:
transforming a question correct rate of the learning element into the fourth point when the online learning platform is utilized by the remote device, wherein the question correct rate of the learning element is proportional to the fourth point.

23. The skill evaluation method of claim 19, wherein the step of quantifying the learning result as the fourth point, further comprises:
transforming a game score of the learning element into the fourth point when the online learning platform is utilized by the remote device, wherein the game score is proportional to the fourth point.

24. The skill evaluation method of claim 19, wherein the step of quantifying the learning result as the fourth point, further comprises:
transforming the learning result into the fourth point according to a predetermined weight setting.

25. The skill evaluation method of claim 1, wherein the step of utilizing the professional skill data further comprises:
calculating to provide a percentile rank of the remote device with respect to other remote devices according to the professional skill data of the remote device and other professional skill data of the other remote devices.

26. The skill evaluation method of claim 1, wherein the step of utilizing the professional skill data further comprises:
matching the professional skill data of the remote device with a demand standard of at least one matching demand to generate a matching result.

27. A computer readable storage medium for storing a computer program, the computer program comprises a plurality of program codes which are downloaded in an internet-accessible device so that the internet-accessible device is able to execute a skill evaluation method of claim 1.

28. An online learning system, comprising:
a server comprising:
a network transmission device for providing at least one remote device to log in the online learning system;
a professional skill acquiring device for quantifying a learning result of an online learning process executed by the remote device on the online learning platform to obtain a professional skill data;
a soft skill acquiring device for quantifying an online community interaction of the remote device on the online learning platform to obtain a first soft skill data; and
a learner database for storing the professional skill data and the first soft skill data.

29. The online learning system of claim 28, wherein the soft skill acquiring device comprises:
a community interaction database;
a community interaction recording device operated for recording a plurality of community interaction messages being transmitted or received in the online learning system by the remote device into the community interaction database, and quantifying the community interaction messages as first points, respectively; and
a soft skill analyzing device operated for calculating the first points to be the soft skill data of the remote device.

30. The online learning system of claim 29, wherein the community interaction messages are selected from a group consisting of an article publishing message, an article replying message, an article recommending message, a thumbs up message, a subject approximation message, a best solution message and a virtual gift giving message.

31. The online learning system of claim 28, wherein the professional skill acquiring device comprises:
a learning content database operated for storing at least one parent subject comprising a plurality of subsidiary subjects, and each of the subsidiary subjects comprises at least one learning element;
a learning device operated for providing the remote device to use at least one learning element, recording the learning result that the remote device using the learning element, and quantifying the learning result as a fourth point; and
a professional skill analyzing device operated for calculating the forth point to be the professional skill data of the remote device.

32. The online learning system of claim 31, wherein the learning element is selected from a group consisting of a film, an article, a question and a game.

33. The online learning system of claim 31, wherein the learning content database is provided with a checking table, wherein the learning device refers to the checking table and quantifies the learning result as the fourth point according to the learning result.

34. The online learning system of claim 31, wherein the learning content database is provided with a weight setting table, wherein the learning device refers to the weight setting table, and quantifies the learning result as the fourth point according to a sort of one of the subsidiary subjects or the parent subject.

35. The online learning system of claim 31, wherein the professional skill acquiring device is further operated to respectively quantify an accomplishment of the subsidiary subjects of the parent subject executed by the remote device in the online learning process to obtain a second soft skill data.

36. The online learning system of claim 35, wherein the learning device is further operated to determine whether the remote device completes at least one of the subsidiary subjects, and quantify to obtain a second point according to a level of the subsidiary subject when the remote device completing the subsidiary subject is determined, wherein the professional skill analyzing device is operated to calculate the second point to be the second soft skill data of the remote device.

37. The online learning system of claim 35, wherein the learning device is further operated to determine whether the remote device completes all subsidiary subjects, and quantify to obtain a second point according to a level of the parent subject when the remote device completing the subsidiary subject is determined, wherein the professional skill analyzing device is operated to calculate the second point to be the second soft skill data of the remote device.

38. The online learning system of claim 31, wherein the professional skill acquiring device is further operated to respectively quantify accomplishment efficiency of the online learning process executed by the remote device to obtain a third soft skill data.

39. The online learning system of claim 38, wherein the learning device is further operated to respectively calculate a ratio of actual spending time and suggested accomplishment time of each of the subsidiary subjects been accomplished by the remote device, and quantify to obtain a third point respectively according to the ratio thereof,
wherein the professional skill analyzing device is operated to calculate the third point to be the third soft skill data of the remote device.

40. The online learning system of claim 38, wherein the learning device is further operated to calculate a ratio of actual spending time and suggested accomplishment time of the parent subject being accomplished by the remote device, and quantify to obtain a third point respectively according to the ratio thereof, and
wherein the professional skill analyzing device is operated to calculate the third point to be the third soft skill data of the remote device.

41. The online learning system of claim 28, wherein the server further comprises:
a graphing device for graphing charts according to the professional skill data and the first soft skill data.

42. The online learning system of claim 28, wherein the server further comprises:
a sorting device for calculating to provide a percentile rank of the remote device according to the professional skill data of the remote device and other professional skill data of other remote devices, and calculating to provide a percentile rank of the remote device according to the first soft skill data of the remote device and other soft skill data for other remote devices.

43. The online learning system of claim 28, wherein the server further comprises:
a matching device for matching at least one of the professional skill data and the first soft skill data for the remote device with a demand standard of at least one matching demand to generate a matching result.
